(19) United States
(12) Patent Application Publication
(10) Pub. No.: US 2026/0070378 A1
(43) Pub. Date: Mar. 12, 2026

(54) TIRE ANALYTICS SYSTEM USING TREAD WEAR RATE

(71) Applicant: Bridgestone Americas Tire Operations, LLC, Nashville, TN (US)

(72) Inventors: Steven NOYCE, Mebane, NC (US); David Alan KOESTER, Burlington, NC (US); Jesko VON WINDHEIM, Durham, NC (US)

(21) Appl. No.: 19/101,921

(22) PCT Filed: Sep. 12, 2023
(86) PCT No.: PCT/US2023/032473

§ 371 Date: Feb. 7, 2025

Related U.S. Application Data
(60) Provisional application No. 63/405,625, filed on Sep. 12, 2022.

(51) Int. Cl. B60C 11/24; G01M 17/02

(52) U.S. Cl. CPC B60C 11/246; G01M 17/02

(57) ABSTRACT

A tire analytics system can include processing circuitry and memory coupled to the processing circuitry. The memory can include instructions stored therein that are executable by the processing circuitry to cause the tire analytics system to perform operations. The operations can include determining a tread wear rate of a tire. The operations can further include determining a maintenance recommendation based on the tread wear rate of the tire. The operations can further include providing an indication of the maintenance recommendation.

### CROSS REFERENCE TO RELATED APPLICATIONS

This application claims the benefit of priority from U.S. Provisional Application No. 63/405,625 filed Sep. 12, 2022, the disclosure and content of which are incorporated by reference herein in their entirety.

### TECHNICAL FIELD

The present disclosure relates generally to vehicle maintenance, and more particularly to a tire analytics system that uses tread wear rate.

### BACKGROUND

Currently, tire pressure sensors may be provided in vehicle tires. Such sensors may be used to automatically monitor tire pressure, and a warning (e.g., a warning light) may be provided to the driver when low pressure is detected. Other aspects of the tire, however, may require manual monitoring and failure to adequately monitor such aspects may cause issues relating to safety and tire use inefficiency. Moreover, replacing and/or rotating tires too early can be expensive, especially for operators of vehicle fleets, which can include hundreds of vehicles.

In some examples, issues with a vehicle, vehicle operator, or driving route can result in increased maintenance demands. Identifying these issues or even identifying the increased maintenance demands can be difficult. Accordingly, improved monitoring of vehicle tires may be desired.

### SUMMARY

According to some embodiments, a method of operating a tirc analytics system is provided. The method includes determining a tread wear rate of a tire. The method includes determining a maintenance recommendation based on the tread wear rate of the tire. The method includes providing an indication of the maintenance recommendation.

According to other embodiments, a tire analytics system, a computer program, a computer program product, or a drive-over-system (“DOS”) is provided to perform the above method.

Various embodiments can provide technical advantages. In some embodiments, a tire analytics system can be provided to improve the monitoring, maintenance, and safety of vehicles.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a perspective view illustrating an example of a drive over system for providing tire measurements in accordance with some embodiments;

FIG. 2 is a graphical display illustrating an example of a plurality of tread depth measurements taken over time for each tire of a vehicle in accordance with some embodiments;

FIG. 3 is a graphical display illustrating an example of a plurality of tread depth measurements taken over time for each vehicle of a vehicle fleet in accordance with some embodiments;

FIG. 4 is a graph illustrating an example of remaining tread depth distribution of tires in a vehicle fleet in accordance with some embodiments;

FIG. 5 is a graph illustrating an example of a plurality of tread depth measurements taken over time for each vehicle of a vehicle fleet in accordance with some embodiments;

FIG. 6 is a block diagram illustrating an example of a tire analytics system in accordance with some embodiments; and

FIG. 7 is a flow chart illustrating an example of operations performed by a tire analytics system in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Various embodiments described herein provide a tire analytics system and procedure for detecting maintenance issues based on tread wear rates. In some examples, the maintenance issues include issues with a specific tire on a vehicle, a specific vehicle in a fleet of vehicles, a vehicle operator (e.g., driver) among a plurality of vehicle operators, and/or a specific route among a plurality of routes. In additional or alternative examples, the tread wear rates are associated with a single tire, a single wheel of a vehicle, multiple wheels of a vehicle, and/or wheels on multiple vehicles of a fleet of vehicles.

In some embodiments, a tire analytics system determines a tread wear rate. In some examples, the tire analytics system includes a sensor or subsystem for measuring one or more characteristics of a tire. In additional or alternative examples, the tire analytics system includes a communication interface for receiving an indication of one or more characteristics of the tire. The one or more characteristics can include the tread wear rate or may be used to determine the tread wear rate.

In some examples, the characteristics can include an indication of two tread depth measurements and a time or distance driven on the tire associated with each tread depth measurement. The tread wear rate can be determined based on dividing the difference of the tread depth measurements by the difference in the time or distance. In additional or alternative examples, the characteristics can be associated with a tire pressure of the tire, an identifier of the tire, a wheel position of the tire, an identifier of a vehicle on which the tire is (or has been) positioned, an identifier of a vehicle operator associated with the vehicle on which the tire is (or has been) positioned. These additional characteristics may be used to determine the tread wear rate or may be used in addition to the tread wear rate to determine maintenance issues and/or responses to the maintenance issues.

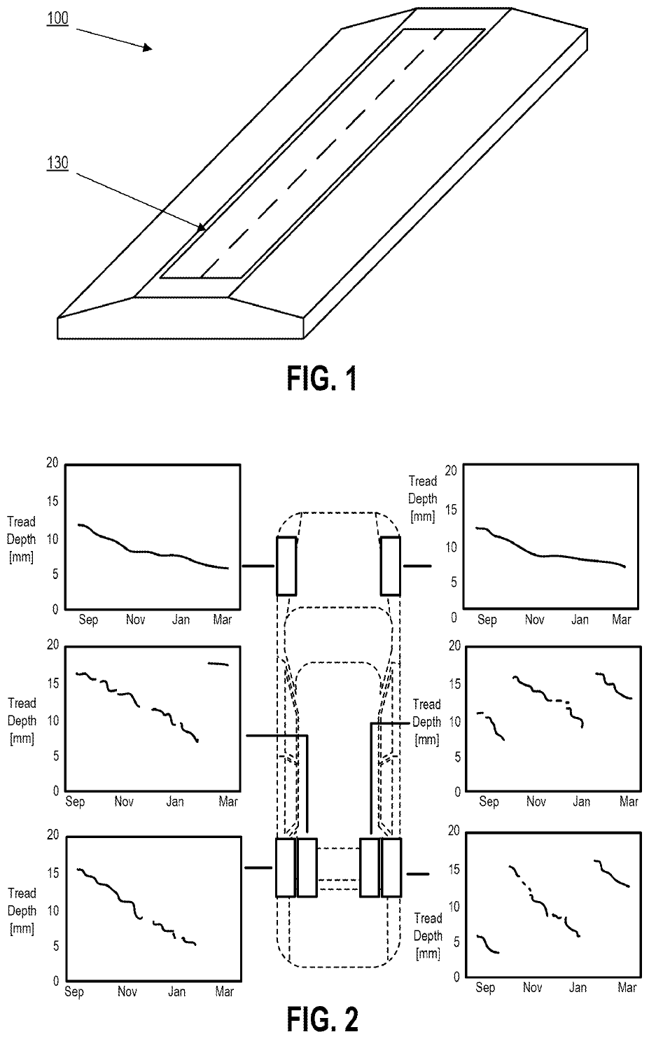

FIG. 1 illustrates an example of a DOS 100 that can determine one or more characteristics (e.g., tread depth or tire pressure) of a tire that drives across it. As described above, a tire analytics system can include a measurement system (like the DOS 100) or may be communicatively coupled to a measuring system (like the DOS 100). The DOS 100 can have a housing with a shape similar to a speed bump (though any suitable shape can be used) with a first slope that rises to a flat area and a second slope that extends back down from the flat area. A metal plate 130 may be positioned over the flat area to provide a drive over surface. The DOS 100 can include a magnetic, optical, or electronic sensor for measuring the tread depth at one or more positions (circumferentially, axially, or radially) on the tire. For example, a DOS can include a magnetic sensor system used to determine the thickness of rubber on a tire outside of the steel belts. This thickness may include both the tread rubber and the thin layer(s) of rubber between the bottom of the grooves and the steel belts, and this thickness may be used to determine a tread depth (also referred to as a tread thickness). The system may be enclosed in a housing that protects the electronics, sensors and magnets, and the housing may provide a structure for vehicles to drive over, allowing the sensors to measure the response of the tires to the induced magnetic fields generated by the magnets in the housing.

In additional or alternative examples, a DOS may include a magnetic sensor that, when coupled with magnets (e.g., permanent magnets or electromagnets) aligned in a plane orthogonal to the plane in which the sensor resides, provides for measurement of the magnetic field associated with the steel belts in response to the magnets when the tire is directly adjacent to the array. Similarly, an array of sensors with a concomitant array of magnets can be employed to measure fields along the length of an array. A plate of non-magnetic material (e.g. aluminum, Delrin, etc.), also referred to as a non-magnetic layer or non-magnetic plate, can be placed over the top of the array of sensors and magnets to protect them from the tire rolling over the array. Poles of the magnets (e.g., permanent magnets and/or electromagnets) can each be oriented vertically, either all north poles N face up and all south poles face down, or all south poles S face up and all north poles N face down.

In additional or alternative examples, the DOS 100 may measure characteristics of a tire including a load on the tire and an area of a contact patch. The DOS 100 can include processing circuitry for determining a pressure (generally referred to as a tire pressure) in the tire based on the load and the area of the contact patch. The housing of the DOS 100 can include a cavity. A linear sensor array can be positioned within the cavity and extends the length of the metal plate 130. The linear sensor array can include magnets and/or magnetic sensors that can measure a change in a magnetic field caused by a tire driving over the DOS 100. In some examples, the change in the magnetic field can be used to determine an area of a contact patch. In additional or alternative examples, a different sensor (e.g., a pressure sensor, load sensor, strain gauge, or capacitor) is used to determine a load on the tire.

In additional or alternative examples, the DOS 100 can include a RFID tag reader that can read RFID tags associated with vehicles, tire, and/or vehicle operators and associate measurements with the corresponding vehicle, tire, and/or vehicle operator.

In some embodiments, a tire analytics system can receive an indication of manual measurements (e.g., taken with a tire gauge). Manual measurements can generally measure tread depth to within (±) 0.5 mm, which on a truck or a bus can equate to 5-10 k miles on a tire that may be rated to operate for 60 k miles or more. To be precise, a technician may have to make multiple measurements, measuring each tread with the gauge and possibly also measuring around the circumference of the tire. Field conditions can make this very difficult and less reliable than automated measurement techniques.

Optical measurements on tires can be performed with laser scanning, which has very high precision and accuracy, measuring distances to ±0.1 mm. However, optical scanners can require line-of-sign to operate (e.g., the scanning laser may have to penetrate all the way into the tread groove to deliver an accurate tread profile). This can impact dynamic range because full penetration may be difficult to achieve in thick treads, leading to a loss of fidelity for truck and bus tires, which have much deeper treads when they are new.

An even greater impact on accuracy for optical scanners can include dirt and debris, both in the tire tread and on any surfaces (e.g., protective glass windows) that reside between the optical system and the tire. Dirt and debris can lead to significant inaccuracies in optical systems: a tread filled with dirt or snow will measure like a worn-out tire; dirt on optical surfaces will result in scatter of the optical signal, potentially leading to random data readings. For this reason, operators may need to ensure clean tires and regular system maintenance (cleaning) to ensure accuracy and precision of the optical scanner is maintained.

For these reasons, optical tire tread monitoring systems are typically deployed in service centers where the environment is controlled and they are typically deployed to aid in tire inspection during service.

In contrast to its competitors, solid state sensors can monitor tread thickness from either inside or outside the tire. In some examples, a DOS includes a low-profile speedbump that senses tread thickness electronically as a tire passes over it. The DOS can be easy to deploy, inexpensive, and can be operated with low or no maintenance. In some examples, the surface-mounted speedbump can be deployed in a service lanes in less than three hours, indoor or outdoor, and can begin collecting data as soon as vehicles drive over it. The solid-state measurements are unaffected by debris in the tire tread or by dust and dirt in the surrounding environment. This means that there is not a need to change fleet operations in any way in order to monitor tire tread with DOS. Every time a vehicle drives over the DOS, tread depth measurements are taken for all tires (including dual tire axels) and associated with the specific vehicle in a database. Regular drive-over events, enable lifetime monitoring of tire health. The significant volume of tread depth data can be used by a tire analytics system to offer predictive analytics on vehicles, tires, and fleet-related usage and maintenance cycles.

Currently, there is a wide range of practices when it comes to tire monitoring by vehicle fleets (e.g., city busses). This range of practices can span from having no formal tire monitoring system, to performing manual inspection every 90-120 days. In some examples, tire monitoring is limited to simple visual inspection or inspection with a tire gauge. Moreover, if documentation is performed, it is most likely to be in the form of hand-written notes and there is no consolidated database of tire tread states.

Using a DOS, data can be collected and managed through an online database in real time as vehicles pass over the DOS or alternatively, displayed back to the shop floor or service lane through a simplified interface that alerts the service technician to actionable tire issues as the vehicle enters the service lane. The tire information provided by the DOS to the shop floor display can be faster and more consistent than manual techniques and the DOS can record all historical data for each tire.

In some embodiments, compiling data about multiple tires currently on the same vehicle, multiple tires that have been on the same vehicle at different times, and/or multiple tires on different vehicles in a fleet of vehicles can allow for analysis and recognition of maintenance issues that are difficult if not impossible for a technician to recognize measuring one tire at a time. For example, a tire analytics system can use tread depth measurements from two rear tires to quickly identify a tread mismatch. This condition is in fact much harder for a service technician to pinpoint because it requires careful measurement with a tire gauge on all the rear tires-something that takes a lot of time and is difficult to do. Furthermore, if there is uneven wear on inside rear tire, that can also be hard to identify without careful inspection. This also assumes that the technician actually has the time to complete a detailed inspection.

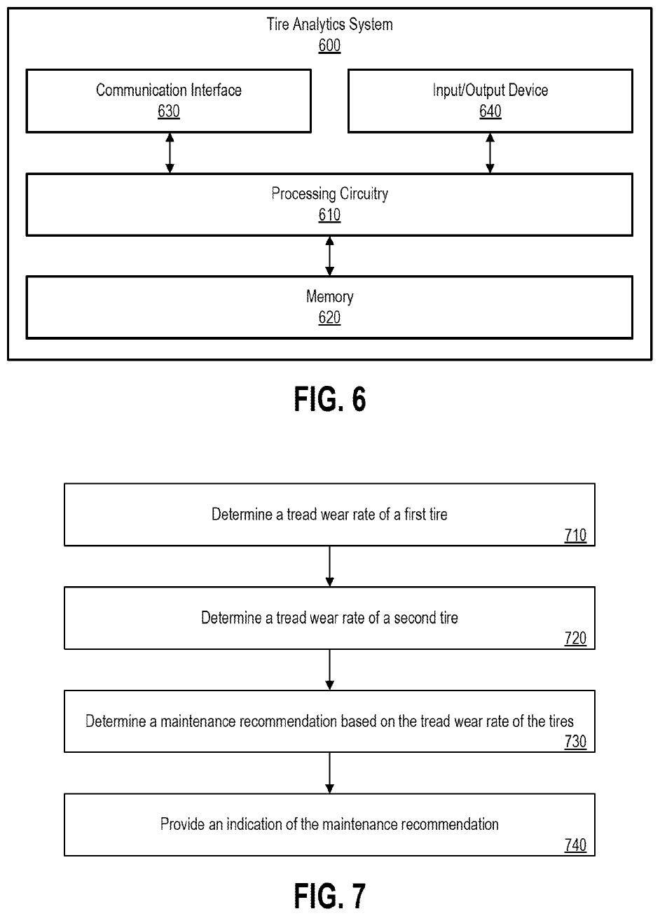

There are good reasons why vehicle inspections are not always fully carried out. Some inspection sites may see from 50-500 vehicles per day, monitoring 300-5,000 wheel positions per site. Inspection sites may be open 24 hours per day, but vehicles tend to cluster in the morning and the evening hours. Consequently, a service technician may be forced to perform inspections based on an innate sense of the vehicle condition as opposed to a thorough measurement of each tire. The combination of an automatic data collection system (e.g., the DOS 100 in FIG. 1) and a tire analytics system (e.g., tire analytics system 600 in FIG. 6) can make it possible to filter 5,000 tires down to 10 or 20 that need to be looked at much more carefully for further action. Moreover, the tire analytics system can use the tire data to identify, predict, and respond to maintenance concerns associated with specific tires as well as maintenance issues with vehicles (e.g., wheel/axel imbalances), vehicle operators (e.g., bad braking habits), and routes (e.g., taking too many left turns or poorly finished roads).

Based on regular tread measurements, tires can be automatically binned according to their real-time wear condition, allowing the fleet operator to focus primarily on worn tires that need attention. However, binning is only the start of the functionality of the system. Once data is in the tire analytics system, various analytical tools can be employed to improve the efficiency of the fleet with direct, positive impact on financial performance and environmental sustainability.

With a DOS in place to carry out automated tread depth measurements, tires within a fleet can be monitored regularly (e.g., daily or whenever a vehicle passes through the service lane) over the life of the tire. In addition, a vehicle's wheel position can be monitored in the long term. This is an important distinction, since long term tire performance can be indicative of wheel position performance, vehicle performance, driver performance, and route characteristics.

FIG. 2 illustrates an example of a graphical display that can be provided by a tire analytics system based on data associated with tread depth of tires on a vehicle that was tracked daily and recorded relative to a wheel position on the vehicle. Vehicle identification was managed through an RFID tagging system that was integrated with the DOS measurements and tire position was managed by the DOS itself. Even without a detailed statistical analysis, FIG. 2 provides an excellent example of a simple tire comparison that cannot be achieved with the regular direct tread depth measurement functions provided by a DOS.

It should be noted that the data collected in FIG. 2 is virtually impossible to be done manually at this scale. For example, a typical truck tire has four tread grooves. So to thoroughly check the treads on an 18-wheel tractor-trailer requires at least 72 independent measurements. Multiply that by even 10 vehicles per day and you have 180 tires requiring 720 measurements for thorough inspection. That requires about 1 measurement every 40 seconds in an 8-hour shift, and more if vehicles are not distributed evenly throughout the day. However, in some embodiments a tire analytics system could still identify and respond to maintenance issues based on manually collected data.

In some examples, a tire analytics system may flag the right front (steer) tires of two new EV buses because they were wearing unevenly. This uneven wear may not be identified by inspection, but may be identified by the tire analytics system soon after the new buses were registered in the system. The problem may be identified early enough to retain the tire casings and rotate the tires to the back (drive) tires. These tires likely would be driven to ruin if automated monitoring does not flag the problem.

In additional or alternative examples, the fact that both vehicles show very similar degradation on the right front tire, can be detected by the tire analytics system, which can suggest a deeper look and ultimate diagnosis of a misalignment in both wheel positions. The alignment can be fixed such that uneven wear is not expected on the next set of steer tires on these buses.

In some embodiments, the tire analytics system may provide indication of the maintenance issue or a recommendation for handling the maintenance issue by outputting an audible or visual alert. In additional or alternative embodiments, the tire analytics system may transmit an indication of the maintenance issue or a recommendation for handling the maintenance recommendation to a device associated with a human service technician, an automated service device, a device associated with the vehicle operator, or the vehicle itself.

The insight gained from the EV bus example is really only scratching the surface of what tire data can do for a vehicle fleet. Millions of miles of tire data can be collected including data sets of bus fleets, less-than-load (“LTL”) truck fleets, last-mile fleets, and various other services and delivery fleets. This data can provide a unique insights into how tire data can be deployed to create value for a fleet. A tire analytics system can provide both enhancements that are achieved with tire data as well as new functionalities that are enabled by tire data.

In some examples, the first level of data deployment by the fleet can enhance the current standard of tire monitoring practice by providing on-demand, actionable tire information to the service technician. In this example, the service lane inspection becomes much easier and more targeted, freeing the technician to focus on fully evaluating and acting upon the most pressing tire problems. A ‘bad actor’ is a term that can be used to define a wheel position within a fleet that may have systemic problems. In this example, not only are immediate problems with a tire being identified, but historical problems within a vehicle can be traced allowing for identification of problems that are occurring across vehicles or even routes.

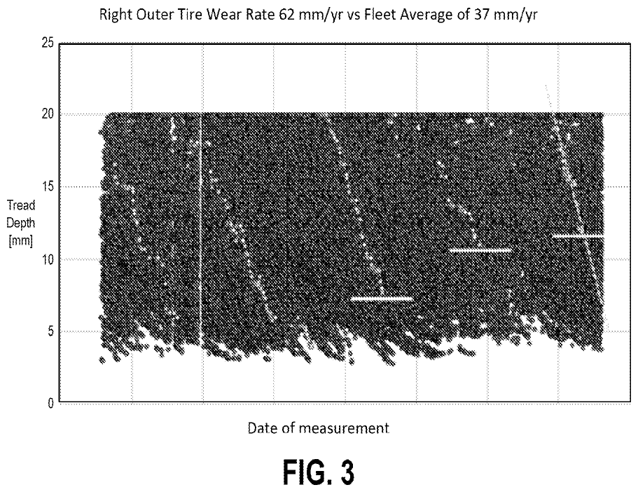

FIG. 3 illustrates an example of tread depth measurements taken across time for each tire of a fleet of vehicles. In this example, a ‘bad actor’ can be identified in a fleet out of 30,000,000 miles of tread wear data. Here, the tire analytics system looked for vehicles with tread wear rates that significantly exceeded the norm, identifying a bus with a 2-year average drive tire tread wear rate of 44 mm/year versus a norm of 37 mm/year. Further analysis by the tire analytics system found that this bus consistently had high wear rates of 47 mm/year on its right outer tire (white data points in FIG. 3). It was also found that tires on this wheel position were being removed earlier and earlier by the service technician (solid white lines in FIG. 3) with the most recent tire wearing at 62 mm/year (dashed white line FIG. 3). Further investigation found that the right inner drive tire—the matching partner to the outer tire—on this vehicle also performed very poorly with a recent wear rate of 70 mm/year; therefore, it would appear that this vehicle has a misalignment in the right rear dual tires, or some other form of mechanical fault.

It should be noted that this problem on the bus had been going on for quite some time (at least over a year), as evidenced by the early tire changes in FIG. 3. The question might be asked why this obvious mechanical fault had not been addressed sooner in service. However, from the perspective of the service technician, they are very much like the farmer standing in the middle of their field of corn: It's easy enough during inspection to identify and address the fact that the tire needs to be changed; however, without the analytical tools offered by the tire analytics system, there is no historical information available to the technician, and consequently the root cause of the problem on this bus—likely misalignment on the right dual wheel position—was not addressed.

Clearly, automation and data analytics can change this perspective dramatically—with the tire analytics system the fleet can have the tools to continuously analyze and optimize vehicle performance, minimize cost and maximize sustainability. Interestingly, the concept of a fleet tire analysis is non-existent in the industry. Accordingly, even if a service technician had access to this kind of data, they may not be able to identify the maintenance issues and provide maintenance recommendations that are made available by the tire analytics system.

In some embodiments, tire data can be linked to key performance indicators (“KPIs”) to help drive optimization. Vehicle fleets can have tire change policies that support their tire management strategy. The goal of these policies can be to manage the trade-offs between using the tire as long as possible while also maintaining safety, protecting the casing for retreading, and avoiding tread mismatches to protect mechanical integrity of the vehicle. But currently there is no feedback loop between these policies and what is actually happening on the shop floor.

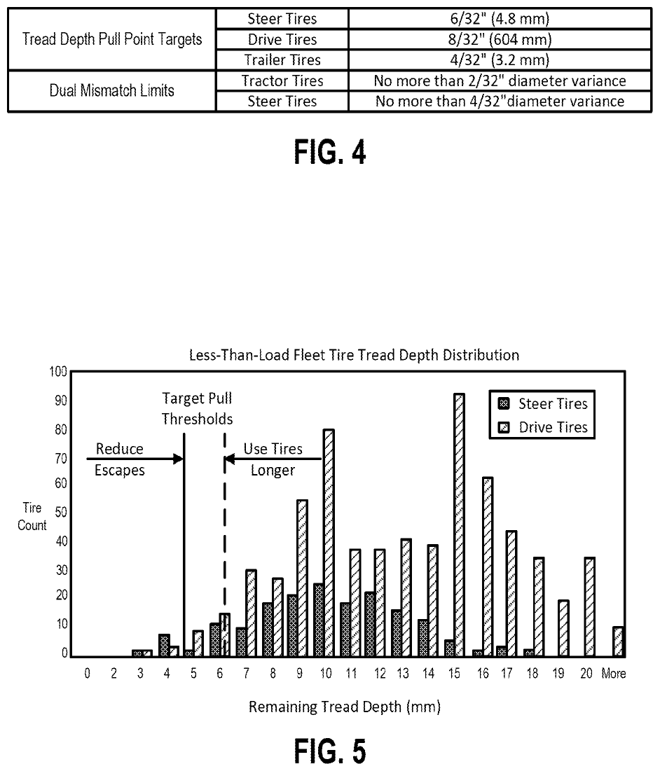

An example tire pull policy for an LTL truck fleet is shown in FIG. 4. In this case pull points for both drive and steer tires are well above the US regulatory safety threshold of 4/32″ (3.2 mm), with the goal of preserving tire casings for retreading. Trailer tires, on the other hand, are worn all the way to the regulatory threshold as these tires are considered at end-of-life once they hit these targets. Tire mismatches are also of concern as these are unsafe and can lead to expensive mechanical failures.

In some embodiments, the tire analytics system, a daily snapshot of tire tread depth is captured for analysis. An example tread depth snapshot for the LTL fleet is shown in FIG. 5. It is evident from FIG. 5 that this fleet can optimize tire management in two ways: firstly, the fleet has some “escapes” (tires not replaced at the designated threshold or pull point) which impacts safety and also affects fleet cost because escapes lead to damaged casings; secondly, it appears in this snapshot that the fleet is also pulling tires early. Ideally, a larger majority of tires would be managed all the way to their target pull point, to ensure most efficient use of tires. In some examples, implementing the tire analytics system can optimize the use of tires in a vehicle fleet.

In some embodiments, the shape of a tread depth curve among vehicles in a vehicle fleet can be important for maximizing the efficiency of tire use in the fleet. During innovation of the tire analytics system, it was discovered that fleet tire management with DOS and the tire analytics system achieved significant efficiency gains, extending average tire use by 12% without compromising safety, leading to estimated net annual savings for a 60-bus fleet of $60,000 and a 21,000 kg reduction in CO₂ emissions. Pulling tires early can be a consequence of pressure being put on the shop floor to save casings. Escapes (unsafe tires) are often a consequence of not having enough time and resources to do complete inspections. With more data readily available to the service technician through an interface with the tire analytics system and a feedback loop established to help management monitor performance against fleet policies through the tire analytics system, escapes can be reduced, and tires can be managed more efficiently to their pull targets.

Benchmarking is a cornerstone of process improvement and optimization in all mature industries. A formal definition of benchmarking is “the continuous process of measuring our products, services and practices against those of our toughest competitors or companies renowned as leaders.” Key elements of benchmarking include: Selecting a benchmarking subject and defining the process to be improved; Identifying key metrics to drive process improvement;

Identifying collaborators to compare data; Collecting data and comparing results among all collaborators; Establishing process differences; and Targeting future performance.

There has been no comprehensive effort to benchmark tire performance within fleets or across fleets. Given the lack of historical data records available for tire status, it is no surprise that benchmarking has not found its way into tire management. The proposed tire analytics system changes this calculus and creates a fundamentally new approach for fleets to optimize tires, reduce downtime, document safety, and minimize cost.

In some embodiments, the tire analytics system allows the tire management process to be viewed holistically with key metrics being: fleet safety, tire performance, tire lifetime and tire cost. In some examples, sustainability is an indirect outcome of tire lifetime extension. The tire analytics system can track all tire brands within fleets. Consequently, for the first time there is enough data available to benchmark tire performance from vehicle-to-vehicle, tire-to-tire, brand-to-brand and industry-to-industry.

FIG. 6 illustrates an example of a tire analytics system 600. The tire analytics system 600 includes processing circuitry 610 communicatively coupled to memory 620, a communication interface 630, and an input/output device 640. The processing circuitry 610 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 610 may include multiple central processing units (CPUs).

The processing circuitry 610 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other tire analytics system 600 components, such as the memory 620, to provide tire analytics system 600 functionality.

In the example, the input/output interface 640 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the tire analytics system 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. In some examples, a sensor may include a measurement system (e.g., a DOS) for measuring tire characteristics (e.g., tread depth measurements). In additional or alternative examples, a sensor may include a RFID reader for identifying a tire, a vehicle, or a vehicle operator. In additional or alternative examples, a sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

Although not illustrated in FIG. 6, the tire analytics system may include a power source structured as a battery or battery pack. Other types of power sources, such as an external power source (e.g., an electricity outlet), photovoltaic device, or power cell, may be used. In additional or alternative examples, the tire analytics system 600 may be distributed across multiple devices via a network and each device may have its own power supply.

The memory 620 may be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 620 includes one or more application programs 620, such as an operating system, web browser application, a widget, gadget engine, or other application, and corresponding data 620. The memory 620 may store, for use by the tire analytics system 600, any of a variety of various operating systems or combinations of operating systems.

The memory 620 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 620 may allow the tire analytics system 600 to access instructions, application programs and the like, stored on transitory or non-transitory memory media, to off-load data, or to upload data. An article of manufacture, such as one utilizing a communication system may be tangibly embodied as or in the memory 620, which may be or comprise a device-readable storage medium. In some examples, the memory 620 includes a data base of historical data associated with a plurality of tires.

The processing circuitry 610 may be configured to communicate with an access network or other network using the communication interface 630. The communication interface 630 may comprise one or more communication subsystems and may include or be communicatively coupled to an antenna. The communication interface 630 may include one or more transceivers used to communicate, such as by communicating with one or more remote transceivers of another device capable of wireless communication (e.g., another tire analytics system, an external measurement system, or a remote database). Each transceiver may include a transmitter and/or a receiver appropriate to provide network communications (e.g., optical, electrical, frequency allocations, and so forth). Moreover, the transmitter and receiver may be coupled to one or more antennas (e.g., antenna) and may share circuit components, software or firmware, or alternatively be implemented separately.

In the illustrated embodiment, communication functions of the communication interface 630 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Other examples of a tire analytics system may include fewer or more elements. For example, some tire analytics systems do not include the input/output device 640. Instead, these tire analytics systems may receive all tire measurements and transmit all maintenance recommendations via the communication interface 630.

Operations of a tire analytics system (e.g., the tire analytics system 600 (implemented using the structure of the block diagram of FIG. 6)) will now be discussed with reference to the flow chart of FIG. 7 according to some embodiments of inventive concepts. In some examples, modules may be stored in memory 620 of FIG. 6, and these modules may provide instructions so that when the instructions of a module are executed by respective tire analytics system processing circuitry 610, processing circuitry 610 performs respective operations of the flow chart.

FIG. 7 illustrates example operations performed by a tire analytics system.

At block 710, processing circuitry 610 determines a tread wear rate of a first tire. At block 720, processing circuitry 610 determines a tread wear rate of a second tire. In some embodiments, determining the tread wear rate of the tire (first or second) includes determining a plurality of tread depth measurements of the tire. Each tread depth measurement of the plurality of tread depth measurements taken at a different time and/or at a different distance driven on the tire. The tread wear rate of the tire can be determined by calculating a curve corresponding to the plurality of tread depth measurements associated with the tire.

In additional or alternative embodiments, the tread wear rate of the tire (first or second) includes a first tread wear rate of a plurality of tread wear rates of the tire, each tread wear rate of the plurality of tread wear rates being associated with a different time window and/or a different window of distance driven on the tire. Determining the tread wear rate of the tire can include determining a plurality of tread depth measurements of the tire. Each tread depth measurement of the plurality of tread depth measurements can be taken at a different time and/or at a different distance driven on the tire. Each tread wear rate of the plurality of tread wear rates can be calculated based on consecutive tread depth measurements of the plurality of tread depth measurements of the tire.

In additional or alternative embodiments, determining the plurality of tread depth measurements includes at least one of: receiving a tread depth measurement from a drive over system; receiving a tread depth measurement from a sensor in the tire; and receiving user input indicating a tread depth measurement.

In additional or alternative embodiments, the plurality of tread depth measurements include tread depth measurements taken at least five times per 1 mm of tread wear of the tire.

In additional or alternative embodiments, determining the tread wear rate of the tire (first or second) includes receiving a first message including an indication of an identifier of the tire, an indication of a first tread depth measurement of the tire, and at least one of an indication of a distance driven on the tire associated with the first tread depth measurement or an indication of a time associated with the first tread depth measurement. The tire analytics system can store an indication of the first tread depth measurement and an indication of at least one of the distance driven on the tire associated with the first tread depth measurement or an indication of the time associated with the first tread depth measurement in memory. The tire analytics system can further receive a second message including an indication of an identifier of the tire, an indication of a second tread depth measurement of the tire, and at least one of an indication of a distance driven on the tire associated with the second tread depth measurement or an indication of a time associated with the second tread depth measurement. The tire analytics system can retrieve the first tread depth measurement and at least one of the distance driven on the tire associated with the first tread depth measurement or the time associated with the first tread depth measurement from memory. The tire analytics system can calculate the tread wear rate of the tire based on dividing a difference in the first tread depth measurement and the second tread depth measurement by either a difference in the distance driven on the tire associated with the first tread depth measurement and the distance driven on the tire associated with the second tread depth measurement or a difference in the time associated with the first tread depth measurement and the time associated with the second tread depth measurement.

At block 730, processing circuitry 610 determines a maintenance recommendation based on the tread wear rate of the tires. In some embodiments, determining the maintenance recommendation includes determining the maintenance recommendation based on a difference in the tread wear rate of the first tire and the tread wear rate of the second tire.

In additional or alternative embodiments, determining the tread wear rate of the tire (first tire and/or second tire) includes determining a plurality of tread wear rates of the tire. Each tread wear rate of the plurality of tread wear rates can be associated with a different time window and/or a different distance driven on the tire. Determining the maintenance recommendation includes determining when to replace the tire based on changes in the plurality of tread wear rates.

In additional or alternative embodiments, the tire (first and/or second) is associated with a vehicle. Determining the tread wear rate of the tire includes determining a plurality of tread wear rates of the tire, each tread wear rate of the plurality of tread wear rates taken at a different position (circumferentially and/or axially) on the tire. Determining the maintenance recommendation includes determining an issue with the vehicle based on differences between tread wear rates of the plurality of tread wear rates of the tire.

In additional or alternative embodiments, the tire wear rate of the first tire is associated with a time in which the first tire was on a vehicle. The tire wear rate of the second tire is associated with a time in which the second tire was on the vehicle. In some examples, determining the maintenance recommendation includes determining an issue associated with the vehicle based on the tread wear rate of the first tire and the tread wear rate of the second tire. In additional or alternative examples, determining the maintenance recommendation includes determining when to replace the second tire on the vehicle based on the tread wear rate of the first tire and the tread wear rate of the second tire. In additional or alternative examples, the first tire and the second tire are associated with a wheel position of the vehicle.

In additional or alternative embodiments, the tire wear rate of the first tire is associated with a time in which the first tire was used by a vehicle operator. The tire wear rate of the second tire is associated with a time in which the second tire was used by the vehicle operator. Determining the maintenance recommendation includes determining an issue associated with the vehicle operator based on the tread wear rate of the first tire and the tread wear rate of the second tire.

In additional or alternative embodiments, the tire wear rate of the first tire is associated with a time in which the first tire was driven along a route. The tire wear rate of the second tire is associated with a time in which the second tire was driven along the route. Determining the maintenance recommendation includes determining an issue associated with the route based on the tread wear rate of the first tire and the tread wear rate of the second tire.

In additional or alternative embodiments, determining the maintenance recommendation includes determining the maintenance recommendation using a machine learning procedure. In some examples, the machine learning procedure uses data from tread wear rates of multiple tires across multiple vehicles, vehicle operators, routes, and tire brands to predict maintenance issues and provide maintenance recommendations improve safety and efficient use of tires.

At block 740, processing circuitry 610 provides, via communication interface 630 or input/output device 640, an indication of the maintenance recommendation. In some embodiments, providing the indication of the maintenance recommendation includes at least one of: displaying the indication of the maintenance recommendation on a graphical display; transmitting the indication of the maintenance recommendation to a vehicle associated with the tire; transmitting the indication of the maintenance recommendation to a device associated with a maintenance provider of the vehicle; activating an alarm associated with a device configured to measure a tread depth of the tire; and transmitting instructions to perform the maintenance recommendation.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” arc intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

The dimensions of elements in the drawings may be exaggerated for the sake of clarity. Further, it will be understood that when an element is referred to as being “on” another element, the element may be directly on the other element, or there may be an intervening element therebetween. Moreover, terms such as “top,” “bottom,” “upper,” “lower,” “above,” “below,” and the like are used herein to describe the relative positions of elements or features as shown in the figures. For example, when an upper part of a drawing is referred to as a “top” and a lower part of a drawing is referred to as a “bottom” for the sake of convenience, in practice, the “top” may also be called a “bottom” and the “bottom” may also be a “top” without departing from the teachings of the inventive concept (e.g., if the structure is rotate 180 degrees relative to the orientation of the figure).

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor (also referred to as a controller) such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following claims and their equivalents, and shall not be restricted or limited by the foregoing detailed description.

1. A method of operating a tire analytics system, the method comprising:
determining a tread wear rate of a tire;
determining a maintenance recommendation based on the tread wear rate of the tire; and
providing an indication of the maintenance recommendation.

2. The method of claim 1, wherein the tire is associated with a vehicle,
wherein determining the tread wear rate of the tire comprises determining a plurality of tread wear rates of the tire, each tread wear rate of the plurality of tread wear rates associated with a different time window and/or a different distance driven on the tire, and
wherein determining the maintenance recommendation comprises determining when to replace the tire based on changes in the plurality of tread wear rates.

3. The method of claim 1, wherein the tire is associated with a vehicle,
wherein determining the tread wear rate of the tire comprises determining a plurality of tread wear rates of the tire, each tread wear rate of the plurality of tread wear rates taken at a different position, circumferentially and/or axially, on the tire, and
wherein determining the maintenance recommendation comprises determining an issue with the vehicle based on differences between tread wear rates of the plurality of tread wear rates of the tire.

4. The method of claim 1, wherein the tire is a second tire,
the method comprising:
determining a tread wear rate of a first tire,
wherein determining the maintenance recommendation comprises determining the maintenance recommendation based on the tread wear rate of the first tire and the tread wear rate of the second tire.

5. The method of claim 4, wherein the tire wear rate of the first tire is associated with a time in which the first tire was on a vehicle,
wherein the tire wear rate of the second tire is associated with a time in which the second tire was on the vehicle, and
wherein determining the maintenance recommendation comprises at least one of:
determining an issue associated with the vehicle based on the tread wear rate of the first tire and the tread wear rate of the second tire; and
determining when to replace the second tire on the vehicle based on the tread wear rate of the first tire and the tread wear rate of the second tire.

6. The method of claim 5, wherein the first tire and the second tire are associated with a wheel position of the vehicle.

7. The method of claim 5, wherein the tire wear rate of the first tire is associated with a time in which the first tire was used by a vehicle operator,
wherein the tire wear rate of the second tire is associated with a time in which the second tire was used by the vehicle operator, and
wherein determining the maintenance recommendation comprises determining an issue associated with the vehicle operator based on the tread wear rate of the first tire and the tread wear rate of the second tire.

8. The method of claim 5, wherein the tire wear rate of the first tire is associated with a time in which the first tire was driven along a route,
wherein the tire wear rate of the second tire is associated with a time in which the second tire was driven along the route, and
wherein determining the maintenance recommendation comprises determining an issue associated with the route based on the tread wear rate of the first tire and the tread wear rate of the second tire.

9. The method of-any claim 1, wherein determining the tread wear rate of the tire comprises:
determining a plurality of tread depth measurements of the tire, each tread depth measurement of the plurality of tread depth measurements taken at a different time and/or at a different distance driven on the tire; and
determining the tread wear rate of the tire by calculating a curve corresponding to the plurality of tread depth measurements associated with the tire.

10. The method of-any claim 1, wherein the tread wear rate comprises a first tread wear rate of a plurality of tread wear rates of the tire, each tread wear rate of the plurality of tread wear rates being associated with a different time window and/or a different window of distance driven on the tire, and
wherein determining the tread wear rate of the tire comprises:
determining a plurality of tread depth measurements of the tire, each tread depth measurement of the plurality of tread depth measurements taken at a different time and/or at a different distance driven on the tire; and
determining a plurality of tread wear rates, each tread wear rate of the plurality of tread wear rates calculated based on consecutive tread depth measurements of the plurality of tread depth measurements of the tire.

11. The method of claim 9, wherein determining the plurality of tread depth measurements comprises at least one of:
receiving a tread depth measurement from a drive over system;
receiving a tread depth measurement from a sensor in the tire; and
receiving user input indicating a tread depth measurement.

12. The method of claim 9, wherein the plurality of tread depth measurements comprise tread depth measurements taken at least five times per 1 mm of tread wear of the tire.

13. The method of-any claim 1, wherein determining the tread wear rate of the tire comprises:
receiving a first message including an indication of an identifier of the tire, an indication of a first tread depth measurement of the tire, and at least one of an indication of a distance driven on the tire associated with the first tread depth measurement or an indication of a time associated with the first tread depth measurement;
storing an indication of the first tread depth measurement and an indication of at least one of the distance driven on the tire associated with the first tread depth measurement or an indication of the time associated with the first tread depth measurement in memory;
receiving a second message including an indication of an identifier of the tire, an indication of a second tread depth measurement of the tire, and at least one of an indication of a distance driven on the tire associated with the second tread depth measurement or an indication of a time associated with the second tread depth measurement;
retrieving the first tread depth measurement and at least one of the distance driven on the tire associated with the first tread depth measurement or the time associated with the first tread depth measurement from memory; and
calculating the tread wear rate of the tire based on dividing a difference in the first tread depth measurement and the second tread depth measurement by either a difference in the distance driven on the tire associated with the first tread depth measurement and the distance driven on the tire associated with the second tread depth measurement or a different in the time associated with the first tread depth measurement and the time associated with the second tread depth measurement.

14. The method of claim 1, wherein providing the indication of the maintenance recommendation comprises at least one of:
displaying the indication of the maintenance recommendation on a graphical display;
transmitting the indication of the maintenance recommendation to a vehicle associated with the tire;
transmitting the indication of the maintenance recommendation to a device associated with a maintenance provider of the vehicle;
activating an alarm associated with a device configured to measure a tread depth of the tire; and
transmitting instructions to perform the maintenance recommendation.

15. The method of-any claim 1, wherein determining the maintenance recommendation comprises determining the maintenance recommendation using a machine learning procedure.

16. A tire analytics system comprising:
processing circuitry; and
memory coupled to the processing circuitry and having instructions stored therein that are executable by the processing circuitry to cause the tire analytics system to perform operations comprising:
determining a tread wear rate of a tire;
determining a maintenance recommendation based on the tread wear rate of the tire; and
providing an indication of the maintenance recommendation.

17-18. (canceled)

19. A non-transitory computer-readable medium having instructions stored therein that are executable by processing circuitry of a tire analytics system to cause the tire analytics system to perform operations comprising:
determining a tread wear rate of a tire;
determining a maintenance recommendation based on the tread wear rate of the tire; and
providing an indication of the maintenance recommendation.
